(19) United States
(12) Patent Application Publication
(10) Pub. No.: US 2013/0033587 A1
(43) Pub. Date: Feb. 7, 2013

(54) EYEWEAR DEVICE

(71) Applicants: Daisuke Kase, Osaka (JP); Isao Ikegami, Hokkaido (JP)

(72) Inventors: Daisuke Kase, Osaka (JP); Isao Ikegami, Hokkaido (JP)

(21) Appl. No.: 13/640,854

(22) PCT Filed: May 24, 2011
(86) PCT No.: PCT/JP2011/002876

§ 371 Date: Oct. 12, 2012

(30) Foreign Application Priority Data
May 24, 2010 (JP) 2010-118001

(51) Int. Cl. H04N 13/04

(52) U.S. Cl. 348/55; 348/E13.026

(57) ABSTRACT

The instant application discloses an eyewear device for assisting in viewing a stereoscopic video. The eyewear device includes a light amount adjuster which adjusts a light amount entering each of left and right eyes; and a controller which controls the light amount adjuster in response to a timing signal for notifying a timing of an increase period during which the transmission amount is increased. The controller includes a detector detecting a non-reception period in which the timing signal is not received; a storage portion storing period data which define a length of the increase period in the non-reception period; and a flywheel controller controlling the light amount adjuster in the non-reception period in response to the period data. If the non-reception period exceeds a threshold period which is defined for the non-reception period, the flywheel controller controls the light amount adjuster so that the increase period is shortened.

### TECHNICAL FIELD

The present invention relates to an eyewear device for assisting in viewing a stereoscopic video, and more particularly to an eyewear device configured to appropriately adjust a period during which image light reaches the eyes of a viewer.

### BACKGROUND ART

An eyewear device for assisting in viewing a stereoscopic video typically includes liquid crystal shutters configured to increase and decrease image light which reaches the eyes of a viewer. The eyewear device receives timing signals to notify opening or closing timings of the liquid crystal shutters, at which the liquid crystal shutters open or close.

Interruption of the timing signals results in an inappropriate opening/closing operation of the liquid crystal shutters. To solve this problem, for example, Patent Document 1 discloses a drive method for appropriately driving the liquid crystal shutters even while the timing signals are interrupted.

There may be phenomena called “crosstalk” under the aforementioned drive control for the liquid crystal shutters during the interruption of the timing signals. As a result of the crosstalk, the right eye of the viewer views a part of a left frame image, which is intended to be viewed by the left eye, and the left eye of the viewer views a part of a right frame image, which is intended to be viewed by the right eye. Since the viewer perceives an image in which the left and right frame images are mixed, qualities of the image perceived by the viewer go down.

FIG. 10 is a schematic timing chart showing the opening/closing operation of the liquid crystal shutters under the conventional drive control. The aforementioned problem associated with the crosstalk is described with reference to FIG. 10. The numeric values in the parentheses in FIG. 10 indicate time.

The Section (a) in FIG. 10 shows images displayed by a display device (not shown) such as a TV and personal computer. The images displayed by the display device include a right frame image, which is viewed by the right eye, and a left frame image, which is viewed by the left eye. The right and left frame images are different in contents by an amount of parallax. Therefore, if a viewer views the right frame image with the right eye and the left frame image with the left eye, the right frame and left images are perceived as a stereoscopic video.

The display device alternately switches and displays the right and left frame images. In the following description, the opening/closing control of the liquid crystal shutters while the right frame image is displayed is mainly described. In the Section (a) of FIG. 10, the period “1100T” is indicated as a right frame image display period.

The Section (b) of FIG. 10 shows timing signals, which are transmitted from the display device to the eyewear device, and the opening/closing operation of the liquid crystal shutter in response to the timing signals.

The liquid crystal shutters typically includes a right shutter, which is situated in front of the right eye of the viewer, and a left shutter, which is situated in front of the left eye of the viewer. The display device transmits a right open signal, which notifies the timing for the right shutter to open, and a right close signal, which notifies the timing for the right shutter to close, to the eyewear device in synchronization with the display period of the right frame image. The right open signal shown in the Section (b) of FIG. 10 is transmitted at the time “110T” after the display start time of the right frame image. The right close signal is transmitted at the time “110T” before the display end time of the right frame image.

The eyewear device, which appropriately receives the right open signal, opens the right shutter substantially in synchronization with the reception of the right open signal. The eyewear device, which appropriately receives the right close signal, closes the right shutter substantially in synchronization with the reception of the right close signal. Accordingly, light of the right frame image reaches the right eye of the viewer in a period from the reception of the right open signal to the reception of the right close signal. The left shutter is closed during the display period of the right frame image. Therefore, the viewer may view the right frame image only with the right eye.

The Sections (c) and (d) of FIG. 10 show the opening/closing operation of the right shutter in a non-reception period without the reception of the aforementioned right open and close signals. The Section (c) of FIG. 10 shows the opening/closing operation of the right shutter when the non-reception period is 1 second long. The Section (d) of FIG. 10 shows the opening/closing operation of the right shutter when the non-reception period is 11 seconds long.

According to the aforementioned conventional techniques, during the non-reception period without the reception of the timing signals, the eyewear device opens and closes the liquid crystal shutters on the basis of timing signals acquired before the non-reception period. This control, however, does not perfectly ensure synchronization between image display timing and opening/closing timings of the liquid crystal shutters.

If there is no reception of the timing signals for 1 second as shown in Section (c) of FIG. 10, the time at which the right shutter opens is at time “121T” after the display start time of the right frame image. The time at which the right shutter is closed is at time “99T” before the display end time of the right frame image. In other words, compared with when the timing signals are appropriately received (see the Section (b) of FIG. 10), the opening/closing timings of the right shutter delay by the time “11T”.

If there is no reception of the timing signals for 11 seconds as shown in Section (d) of FIG. 10, the timing delay of the opening/closing operation of the liquid crystal shutters further increases. Consequently, the right shutter closes during the display period of the left frame image. Since the opening period of the right shutter extends into the display period of the left frame image (crosstalk period), the viewer perceives an image where the right and left frame images are mixed. Therefore, qualities of the image viewed by the viewer go down.

The operational timing delay of the liquid crystal shutter during the non-reception period is described with reference to FIG. 10. A shift direction (delay or advance) of the operation timing of the liquid crystal shutter from the display timing of the image may depend on characteristics of the display device and the eyewear device. Therefore, the problem of the crosstalk described with reference to FIG. 10 may occur when the operation timing of the liquid crystal shutter gradually advances from the display timing of an image.

Patent Document 1: JP H11-98538 A

### SUMMARY

It is an object of the present invention to provide an eyewear device which may decrease crosstalk.

An eyewear device according to one aspect of the present invention assists in viewing a video so that the video is stereoscopically perceived. The eyewear device includes a light amount adjuster which increases and decreases a transmission amount of image light so as to adjust a light amount that enters each of left and right eyes; and a controller configured to control the light amount adjuster in response to a timing signal for notifying a timing of an increase period during which the transmission amount is increased. The controller includes a detector configured to detect a non-reception period in which the timing signal is not received; a storage portion configured to store period data which define a length of the increase period in the non-reception period; and a flywheel controller configured to control the light amount adjuster in the non-reception period in response to the period data. If the non-reception period exceeds a threshold period which is defined for the non-reception period, the flywheel controller controls the light amount adjuster so that the increase period is shortened.

### BRIEF DESCRIPTION OF THE DRAWINGS

FIG. 1 is a block diagram schematically showing a functional configuration of an exemplary eyewear device.

FIG. 2 is a schematic view showing a video system having the eyewear device shown in FIG. 1.

FIG. 3 is a schematic graph showing a voltage signal detected by a timekeeping portion of the eyewear device shown in FIG. 1.

FIG. 4 is a conceptual diagram showing timing data stored in a data memory of the eyewear device shown in FIG. 1.

FIG. 5 is a flow chart schematically showing an adjustment operation for an increase period by the eyewear device depicted in FIG. 1.

FIG. 6 is a schematic timing chart which compares an opening/closing operation of a liquid crystal shutter under conventional drive control with an opening/closing operation of a shutter under control of the present implementation.

FIG. 7 is a schematic timing chart which compares an opening/closing operation of the liquid crystal shutter under conventional drive control with an opening/closing operation of a shutter under control of the present implementation.

FIG. 8 is a schematic timing chart which compares an opening/closing operation of the liquid crystal shutter under conventional drive control with an opening/closing operation of a shutter under control of the present implementation.

FIG. 9 is a flow chart schematically showing an operation to gradually adjust the increase period by the eyewear device depicted in FIG. 1.

FIG. 10 is a schematic timing chart showing an opening/closing operation of the liquid crystal shutter under conventional drive control.

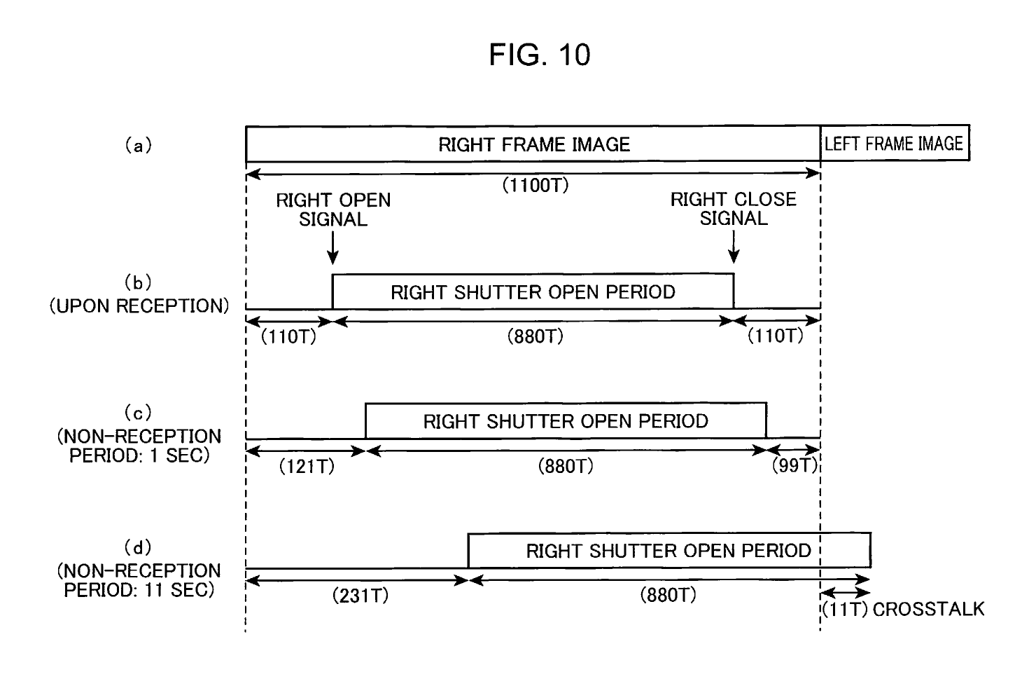

### DETAILED DESCRIPTION

An exemplary eyewear device is described with reference to the accompanying drawings. In the drawings, the same reference numerals are given to constituent elements which have similar or identical functions or operations. Redundant description is omitted as appropriate.

### (Configuration of Eyewear Device)

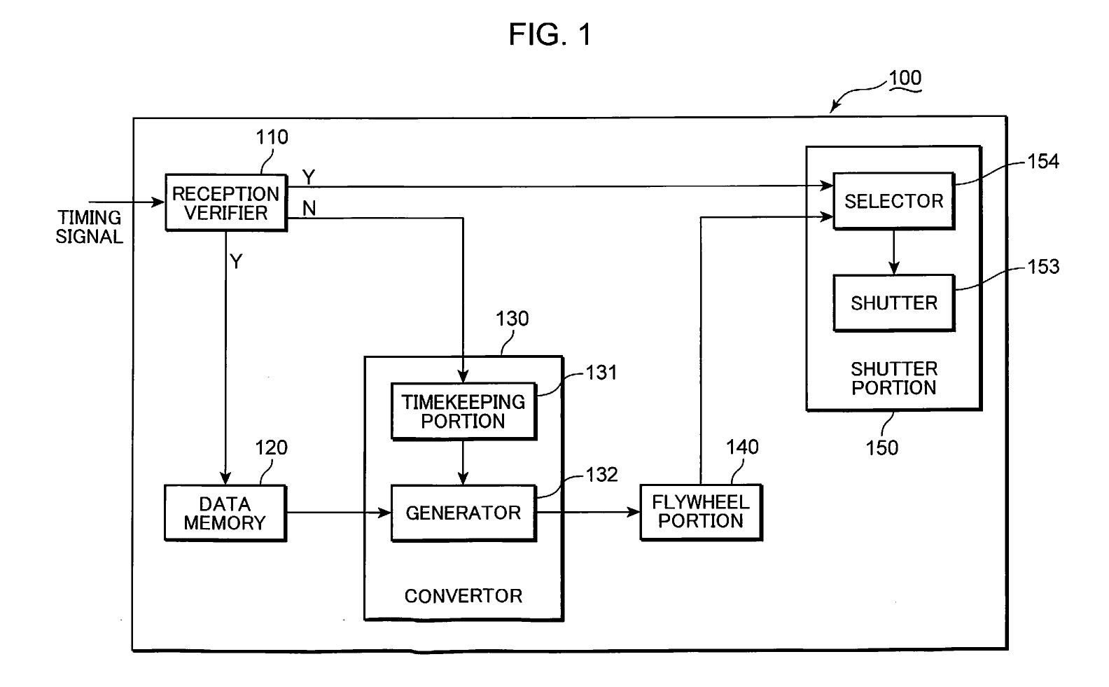

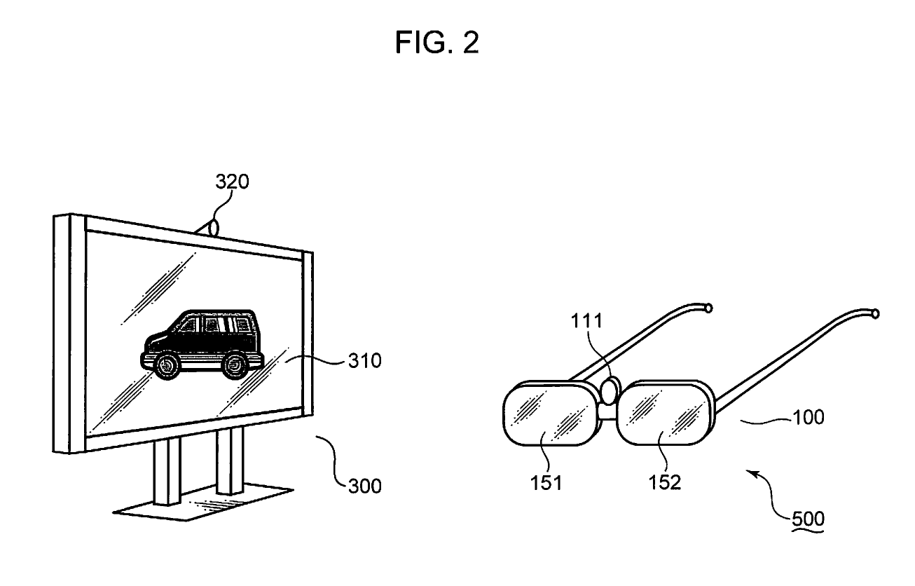

FIG. 1 is a block diagram schematically showing a functional configuration of the eyewear device according to the present implementation. FIG. 2 is a schematic view showing a video system having the eyewear device of the present implementation. The eyewear device is described with reference to FIGS. 1 and 2.

The eyewear device 100 shown in FIG. 1 has a reception verifier 110, a data memory 120, a convertor 130, a flywheel portion 140 and a shutter portion 150. The video system 500 shown in FIG. 2 has a display device 300 configured to display a stereoscopic video, in addition to the eyewear device 100.

As shown in FIG. 2, the display device 300 has a display portion 310 which displays a stereoscopic video. The display portion 310 selectively displays a right frame image, which is viewed with the right eye, and a left frame image, which is viewed with the left eye. The right and left frame images represent different contents by an amount of parallax. Therefore, if a viewer views the right frame image only with the right eye and the left frame image only with the left eye, the image displayed on the display portion 310 is stereoscopically perceived. In this implementation, the display device 300 alternately displays the right and left frame images. The display device may switch the right and left frame images by means of a different display method for allowing the viewer to stereoscopically perceive a video.

As shown in FIG. 2, the eyewear device 100 has a right shutter 151, which is situated in front of the right eye of the viewer, and a left shutter 152, which is situated in front of the left eye of the viewer. The right shutter 151 opens while the display device 300 displays a right frame image, and closes while the display device 300 displays a left frame image. If the right shutter 151 opens, an increased transmission amount of the image light transmits through the right shutter 151. If the right shutter 151 closes, a decreased transmission amount of the image light transmits through the right shutter 151. The left shutter 152 opens while the display device 300 displays a left frame image, and closes while the display device 300 displays a right frame image. If the left shutter 152 opens, an increased transmission amount of the image light transmits through the left shutter 152. If the left shutter 152 closes, a decreased transmission amount of the image light transmits through the left shutter 152. Therefore, while the display device 300 displays a right frame image, the image light amount entering the right eye increases whereas the image light amount entering the left eye decreases. While the display device 300 displays a left frame image, the image light amount entering the left eye increases whereas the image light amount entering the right eye decreases. Consequently, the eyewear device 100 may assist in viewing a video so that the video is stereoscopically perceived. In this implementation, liquid crystal shutter elements are used for the right and left shutters 151, 152. Alternatively, optical elements, which can adjust a light amount entering each of the left and right eyes in response to an image displayed by the display device 300, may be used for the right and/or left shutters 151, 152.

As shown in FIG. 2, the display device 300 includes a transmitter 320 configured to transmit timing signals for notifying the timing of an increase period in which the transmission amount of the image light that passes through the right and left shutters 151, 152 increases. The eyewear device 100 further includes a receiver 111 configured to receive the timing signals. The eyewear device 100 controls the aforementioned opening/closing operation of the right and left shutters 151, 152 in response to the timing signals. The timing signals may be communicated from the transmitter 320 to the receiver 111 by means of a radio method, an infrared method or another technology for realizing the aforementioned synchronization operation between the display device 300 and the eyewear device 100.

In addition to the aforementioned receiver 111, the reception verifier 110 shown in FIG. 1 may include a circuit and a program to remove noise signals from signals received by the receiver 111. The reception verifier 110 confirms that a signal from the display device 300 is appropriately received. In this implementation, the timing signals include a right open signal, which notifies a timing for the right shutter 151 to open, a right close signal, which notifies a timing for the right shutter 151 to close, a left open signal, which notifies a timing for the left shutter 152 to open, and a left close signal, which notifies a timing for the left shutter 152 to close. Therefore, the reception verifier 110 confirms whether the right open signal, the right close signal, the left open signal and the left close signal are appropriately received. The timing signal may be a single command signal for notifying information about the opening/closing timings of the right and left shutters 151, 152 to the eyewear device 100. In this case, the reception verifier 110 confirms whether the command signal is appropriately received. In addition, the reception verifier 110 may extract information about the opening/closing timings of the right and left shutters 151, 152 from the command signal.

As shown in FIG. 1, timing data, which are used to open and close the right and left shutters 151, 152 at opening/closing timings defined by the timing signals, are output from the reception verifier 110, which confirms appropriate reception of timing signals, to the shutter portion 150. The shutter portion 150 has a shutter 153. The shutter 153 shown in FIG. 1 refers to the right and/or left shutters 151, 152 described with reference to FIG. 2. The shutter portion 150 opens and closes the shutter 153 in response to the timing data. The shutter portion 150 is exemplified as the light amount adjuster which increases and decreases the transmission amount of the image light.

The reception verifier 110 outputs the timing data to the data memory 120 as well after confirming appropriate reception of the timing signals. The data memory 120 stores the timing data.

As shown in FIG. 1, the convertor 130 has a timekeeping portion 131 and a generator 132. Unless appropriate reception of the timing signals is confirmed, the reception verifier 110 outputs an activation command to activate the timekeeping portion 131.

For example, the reception verifier 110 determines that appropriate reception of the timing signals is not confirmed in the following cases. The principle of the present implementation, however, is in no way limited to the following exemplary conditions.

(1) The receiver 111 does not receive any timing signal at all.

(2) The reception verifier 110 cannot identify a timing signal from a signal received by the receiver 111 (e.g. receiver 111 received a signal that includes excessive noise signals).

(3) Information about the opening/closing timings of the shutter 153 indicated by the timing signal is significantly different from the previously acquired timing data (e.g. information about opening/closing timings, which is clearly different from the previous timing data, is included in spite of no change in a program displayed by the display device).

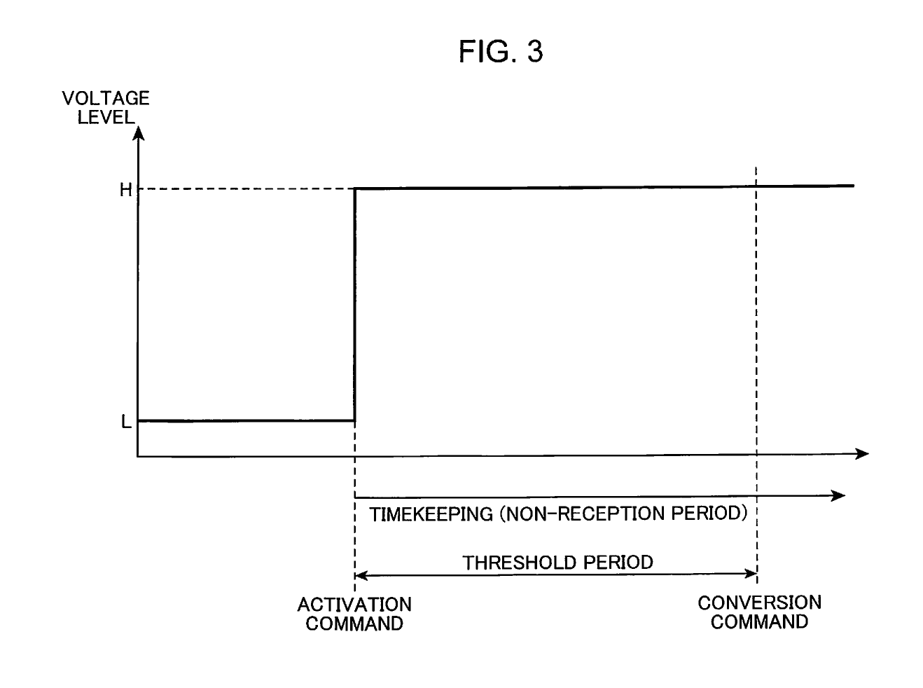

FIG. 3 is a schematic graph showing a voltage signal detected by the timekeeping portion 131. The timekeeping portion 131 is described with reference to FIGS. 1 and 3.

While the reception verifier 110 does not output the activation command to the timekeeping portion 131 (i.e., while the reception verifier 110 confirms appropriate reception of the timing signals), the timekeeping portion 131 detects a low level voltage signal. While the reception verifier 110 outputs the activation command to the timekeeping portion 131 (i.e., while the reception verifier 110 does not confirm appropriate reception of the timing signals), the timekeeping portion 131 detects a high level voltage signal.

The timekeeping portion 131 detecting the high level voltage signal starts keeping a time. The time length measured by the timekeeping portion 131 means a period while the reception verifier 110 does not confirm appropriate reception of the timing signal. Therefore, the period measured by the timekeeping portion 131 is called “non-reception period” in the following description.

The timekeeping portion 131 may store a threshold period which is defined in advance for the non-reception period. If the non-reception period exceeds the threshold period, the timekeeping portion 131 outputs conversion commands to the generator 132. Operation of the generator 132 after reception of the conversion commands is described later.

As described above, the reception verifier 110 confirming appropriate reception of the timing signals outputs the timing data to the data memory 120. The data memory 120 stores the timing data. The data memory 120 outputs the timing data to the generator 132.

Before receiving the conversion command, the timing data received from the data memory 120 are output from the generator 132 to the flywheel portion 140. After receiving the conversion command from the timekeeping portion 131, the generator 132 converts the timing data into converted timing data. The converted timing data are then output to the flywheel portion 140. The timing data conversion processes by the generator 132 are described later.

The shutter portion 150 further includes a selector 154, in addition to the aforementioned shutter 153. The timing data from the reception verifier 110 confirming appropriate reception of the timing signal are input to the selector 154. Meanwhile, the timing data from the flywheel portion 140 are also input to the selector 154. In this implementation, the selector 154 preferentially selects the timing data from the reception verifier 110 to drive the shutter 153.

While the reception verifier 110 outputs the start time, the selector 154 receives only the input from the flywheel portion 140. Unless the non-reception period exceeds the threshold period, the selector 154 receives the timing data from the flywheel portion 140. Meanwhile, the selector 154 drives the shutter 153 in response to the timing data from the flywheel portion 140. If the non-reception period exceeds the threshold period, the selector 154 receives the converted timing data from the flywheel portion 140. Meanwhile, the selector 154 drives the shutter 153 in response to the converted timing data from the flywheel portion 140. If the timing data are output from only one of the reception verifier 110 and the flywheel portion 140, the selector 154 may not be necessary. Therefore, the principle of this implementation is not limited by the selector 154.

As described above, the shutter portion 150 is controlled by the reception verifier 110, the data memory 120, the convertor 130 and the flywheel portion 140 in response to the timing signals. Therefore, in this implementation, the reception verifier 110, the data memory 120, the convertor 130 and the flywheel portion 140 are exemplified as the controller. As described with reference to FIGS. 1 and 3, the reception verifier 110 and the timekeeping portion 131 are used for detecting the non-reception period. Therefore, in this implementation, the reception verifier 110 and the timekeeping portion 131 are exemplified as the detector. In the non-reception period, the shutter portion 150 is controlled in response to the output of the flywheel portion 140. Therefore, the flywheel portion 140 is exemplified as the flywheel controller.

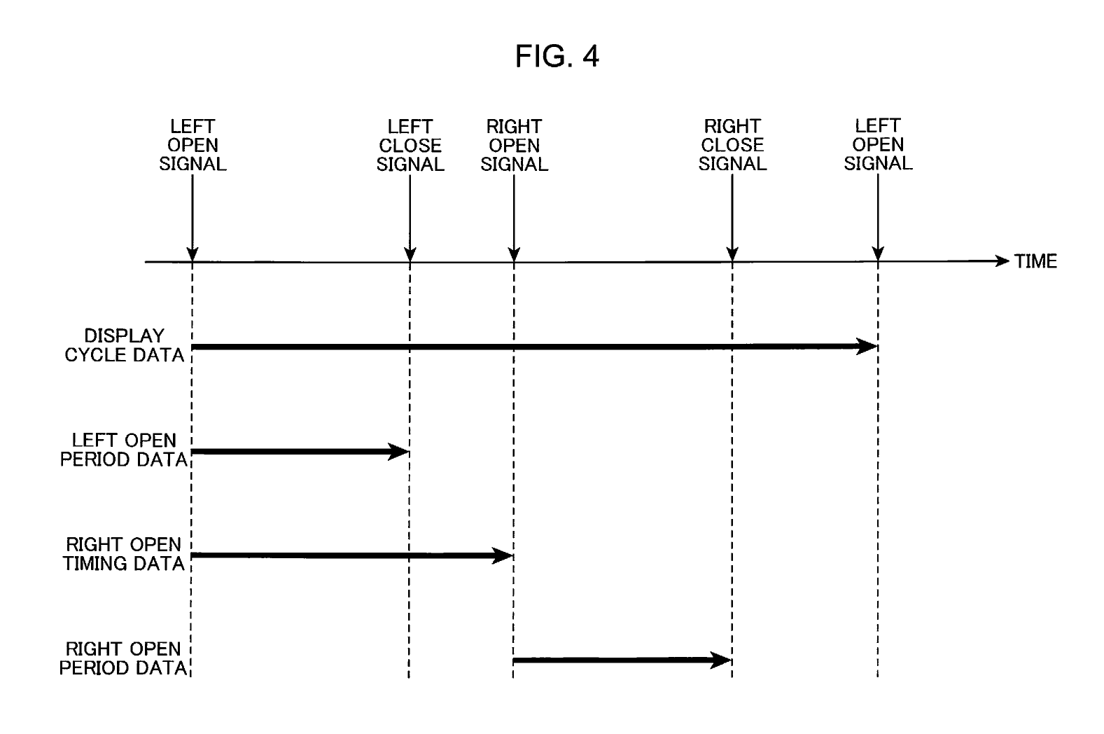

FIG. 4 is a conceptual diagram showing timing data stored in the data memory 120. The timing data are described with reference to FIGS. 1 to 4.

As described above, the eyewear device 100 sequentially receives the left open signal, the left close signal, the right open signal and the right close signal as the timing signals. The data memory 120 stores display cycle data, left open period data, right open timing data and right open period data, which are acquired on the basis of the reception times of the left open signal, the left close signal, the right open signal and the right close signal. In this implementation, the left open and close signals are exemplified as the left timing signal. The right open and close signals are exemplified as the right timing signal.

The display cycle data indicate a difference between the reception times of one first left open signal and the next left open signal. The display cycle data substantially correspond to the display period of the frame image (display period of the left and right frame images).

The left open period data indicate a difference between the reception time of the left open signal and that of the left close signal immediately after the left open signal. The left shutter 152 is opened during a period defined by the left open period data from the reception time of the left open signal. In this implementation, the reception time of the left open signal is exemplified as the data to indicate the start timing. The reception time of the left close signal is exemplified as the data to indicate the end timing.

The right open timing data indicate a difference between the reception time of the left open signal and that of the right open signal immediately after the left open signal. After the period specified by the right open timing data passes from the reception time of the left open signal, the right shutter 151 is opened.

The right open period data indicate a difference between the right open signal and that of the right close signal immediately after the right open signal. After the period defined by the right open period data passes from the time at which the right shutter 151 is opened, the right shutter 151 is closed. In this implementation, the reception time of the right open signal is exemplified as the data to indicate the start timing. The reception time of the right close signal is exemplified as the data to indicate the end timing.

Once the period defined by the display cycle data then passes from the time at which the previous left open signal is received, the left shutter 152 is opened again.

As described above, the left and right open period data specify the length of the increase period in which the transmission amount of the image light to the left and right shutters 152, 151 increases. Therefore, the left and right open period data are exemplified as the period data defining the length of the increase period.

Each of the display cycle data, the left open period data, the right open timing data and the right open period data is input from the data memory 120 to the generator 132. After the reception verifier 110 outputs the activation command to the timekeeping portion 131 and while the non-reception period that does not exceed the threshold period, the generator outputs the display cycle data, the left open period data, the right open timing data and the right open period data to the flywheel portion 140.

Once the non-reception period exceeds the threshold period, the timekeeping portion 131 outputs the conversion command to the generator 132, as described above. The generator receiving the conversion command converts the timing data so that the increase period defined by the left and right open period data is shortened, and outputs the converted timing data. Therefore, the converted timing data include converted period data that indicate a length of the shortened increase period. The flywheel portion 140 then outputs the converted timing data to the shutter portion 150. Accordingly, the shutter portion 150 is controlled so that the increase period is shortened. The process to shorten the increase period is described later.

As described above, the timing data or the converted timing data are input to the flywheel portion 140. The flywheel portion 140 receiving the timing data calculates a time for the left shutter 152 to open, a time for the left shutter 152 to close, a time for the right shutter 151 to open and a time for the right shutter 151 to close, on the basis of the display cycle data, the left open period data, the right open timing data and the right open period data, and outputs control signals to open and close the left and right shutters 152, 151 at the calculated times. The flywheel portion 140 receiving the converted timing data also calculates a time for the left shutter 152 to close, a time for the right shutter 151 to open and a time for the right shutter 151 to close, on the basis of the converted data, and outputs control signals to open and close the left and right shutters 152, 151 at the calculated times. The shutter 150 is controlled by the control signal from the flywheel portion 140 in the non-reception period.

The selector 154 of the shutter portion 150 selects one of the input signals from the reception verifier 110 and the flywheel portion 140 to drive the shutter 153. The reception verifier 110 confirming appropriate reception of the timing signals calculates a time for the left shutter 152 to close, a time for the right shutter 151 to open and a time for the right shutter 151 to close, on the basis of the reception times of the left open signal, the left close signal, the right open signal and the right close signal, and outputs control signals to open and close the left and right shutters 152, 151 at the calculated times. If the reception verifier 110 confirms appropriate reception of the timing signals, the selector 154 selects the control signal from the flywheel portion 140. Unless the reception verifier 110 confirms appropriate reception of the timing signals, the selector 154 selects the control signal from the reception verifier 110. Therefore, the opening/closing operation of the shutter 153 is controlled in response to the control signals from the reception verifier 110 or the flywheel portion 140.

### (Operation of Eyewear Device)

Operation of the eyewear device 100 is described with reference to FIGS. 1 to 4.

As described above, the timing signals are transmitted from the display device 300. The eyewear device 100 uses the receiver 111 to receive the timing signals. The opening/closing operation of the shutter 153 of the eyewear device 100 is controlled in response to the timing signals. In this implementation, the timing signals include the left open signal, the left close signal, the right open signal and the right close signal. The receiver 111 receives the left open signal, the left close signal, the right open signal and the right close signal. The control elements of the eyewear device 100 such as the reception verifier 110, the data memory 120, the convertor 130 and the flywheel portion 140 control the opening/closing operation of the left and right shutters 152, 151 in response to the left open signal, the left close signal, the right open signal and the right close signal.

If the receiver 111 appropriately receives the timing signals, the reception verifier 110 generates control signals to control the shutter 153 in response to the timing signals. Therefore, the shutter 153 opens and closes in correspondence with the reception times of the left open signal, the left close signal, the right open signal and the right close signal.

Unless the receiver 111 appropriately receives the timing signals, the opening/closing operation of the shutter 153 is controlled in response to the control signals generated by the flywheel portion 140. In this implementation, the reception verifier 110 determines whether the timing signals are appropriately received as described above. Therefore, the reception verifier 110 is exemplified as the determination portion.

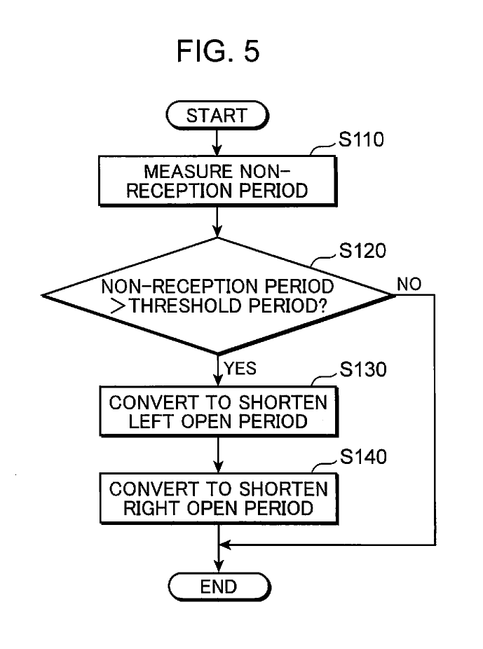

FIG. 5 is a flow chart schematically showing an adjustment operation to the increase period by the eyewear device 100. The adjustment operation to the increase period by the eyewear device 100 is described with reference to FIGS. 1 to 5.

### (Step S110)

Unless the reception verifier 110 confirms appropriate reception of the timing signals, step S110 is executed. In step S110, the reception verifier 110 outputs an activation command to the timekeeping portion 131. The timekeeping portion 131 receiving the activation command starts measuring a period without appropriate reception of the timing signals (i.e., non-reception period). Then step S120 is executed.

### (Step S120)

In step S120, the timekeeping portion 131 compares the non-reception period with the threshold period. Unless the non-reception period exceeds the threshold period, the adjustment process to the increase period, in which an image light amount passing through the left or right shutter 152, 151 increases, ends. In this case, the timing data stored in the data memory 120 (see FIG. 4) are output to the flywheel portion 140 without the conversion process by the generator 132. The control signals are then output from the flywheel portion 140 to the shutter portion 150 to control the opening/closing operation of the shutter 153 in response to the timing data. If the non-reception period exceeds the threshold period, step S130 is then executed.

### (Step S130)

In step S130, the generator 132 converts the timing data into the converted timing data so as to shorten the increase period indicated by the left open period data of the timing data stored in the data memory 120 (period in which a light amount entering the left eye increases). The left open period data to indicate the increase period shortened by the conversion process in step S130 is exemplified as the converted period data. Then, step S140 is executed.

### (Step S140)

In step S140, the generator 132 converts the timing data into the converted timing data so as to shorten the increase period indicated by the right open period data of the timing data stored in the data memory 120 (period in which a light amount entering the right eye increases). The right open period data to indicate the increase period shortened by the conversion process in step S140 is exemplified as the converted period data.

If step S140 is executed, the adjustment process to the increase period, in which an image light amount passes through the left or right shutter 152, 151 increases, ends. As a result of steps S130, S140, the flywheel portion 140 generates control signals to control the shutter 153 in response to the left and right open period data which indicate the shortened increase period. Consequently, if the non-reception period exceeds the threshold period, a period, in which the left shutter 152 is open, and a period, in which the right shutter 151 is open, are shortened.

As described above, the convertor 130 measures a length of the non-reception period without reception of the timing signals. If the non-reception period is longer than the threshold period, the convertor 130 shortens the left and right open periods.

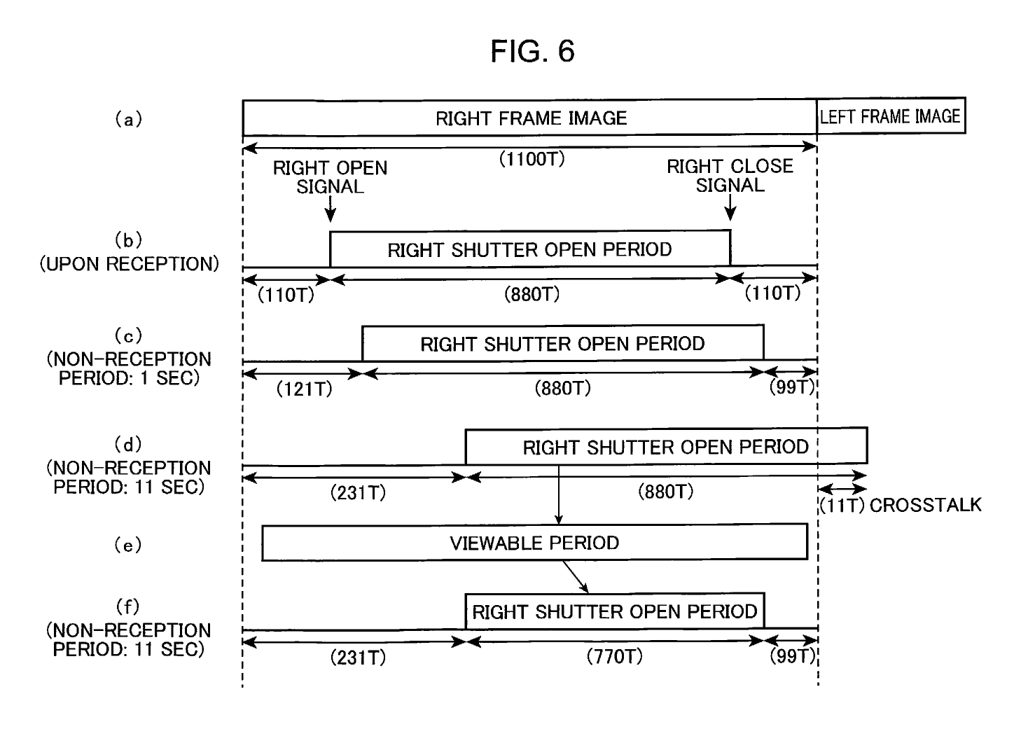

FIG. 6 is a schematic timing chart, which compares an opening/closing operation of a liquid crystal shutter under conventional drive control with an opening/closing operation of the shutter 153 which operates under control of this implementation. Effects of the conversion process described with reference to FIG. 5 are described with reference to FIGS. 1, 2, 4 to 6. The numeric values in the parentheses shown in FIG. 6 indicate time.

The Section (a) of FIG. 6 shows display periods of the right and left frame images on the display device 300. The display device 300 alternately switches and displays the right and left frame images. In the following description, the opening/closing control of the shutter while the right frame image is displayed is mainly described. In the Section (a) of FIG. 6, the period “1100T” is indicated as the display period of the right frame image.

The Section (b) of FIG. 6 shows timing signals transmitted from the display device 300 to the eyewear device 100, and an opening/closing operation of the right shutter 151 in response to the timing signals.

During the display period of the right frame image, the display device 300 transmits a right open signal to open the right shutter 151 (i.e., to notify the start timing at which the increase period starts and a transmitted light amount to the right shutter 151 increases), and a right close signal to close the right shutter 151 (i.e., to notify the end timing at which the increase period ends). The right open signal shown in the Section (b) of FIG. 6 is transmitted at the time “110T” after the display start time of the right frame image. The right close signal is transmitted at the time “110T” before the display end time of the right frame image.

If the receiver 111 of the eyewear device 100 appropriately receives the right open and close signals, the eyewear device 100 controls the opening/closing operation of the right shutter 151 in response to the right open and close signals. For example, if the right open and close signals are appropriately received, the right shutter 151 opens substantially in synchronization with the reception time of the right open signal, and closes substantially in synchronization with the reception time of the right close signal.

The Sections (c) and (d) of FIG. 6 show operation of the right shutter under conventional control which does not adjust the right open period.

The Section (c) of FIG. 6 shows the opening/closing operation of the right shutter when the non-reception period is 1 second. According to the conventional control, the opening/closing operation of the right shutter in the non-reception period is controlled on the basis of the timing signals acquired before the non-reception period. If the timing signals of the Section (b) in FIG. 6 are used as references of the opening/closing control, the open period of the right shutter (right open period) defined by the right open and close signals acquired before the non-reception period becomes “880T”.

During the non-reception period, the start timing of the right frame image, which the display device 300 actually displays, is not directly linked with the eyewear device. The timing of the right open period is simply based on the data acquired in the past. Therefore, the timing of the right open period may be shifted from the actual display timing of the right frame image as a time passes. For example, the direction and amount of the timing shift of the right open period from the actual display timing of the right frame image may depend on characteristics of the display device 300 and the eyewear device. In the Section (c) of FIG. 6, the timing of the right open period delays time “11T” during 1 second of the non-reception period. This means that if there is 1 second of the non-reception period, the right open period starts at “121T” after the display start time of the right frame image.

In the case of the conventional control, the opening/closing operation of the right shutter is controlled while maintaining the length of the right open period, unlike the principle of this implementation. Therefore, the shift of the end time of the right open period also delays time “11T”. Consequently, if there is 1 second of the non-reception period, the right open time ends at time “99T” before the display end time of the right frame image.

The Section (d) of FIG. 6 shows the opening/closing operation of the right shutter when the non-reception period is 11 seconds. The Section (d) of FIG. 6 shows the delay of the right open period, which increases in proportion to a length of the non-reception period, in order to make description clear. If the non-reception period becomes 11 seconds, the start time of the right open period further delays from the start time of the actually displayed right frame image. Therefore, the right open period starts at the time “231T” after the display start time of the right frame image. As described with reference to the Section (c) of FIG. 6, substantially the same shift as the start time shift of the right open period also appears in the end time of the right open period. Consequently, if there are 11 seconds of a non-reception period, the right shutter closes when the time “11T” passes from the display start time of the left frame image. This means that the viewer views not only the right frame image but also the left frame image with the right eye (i.e., crosstalk). The period “11T”, which shifts into the display period of the left frame, is called “crosstalk period”. As the crosstalk period becomes longer, more light of the left frame image enters the left eye of the viewer, which results in worse qualities of the video perceived by the viewer.

The Section (e) of FIG. 6 shows a period during which the right frame image may be appropriately viewed (viewable period). If the right open period is set in the viewable period, the viewer may appropriately view the right frame image only with the right eye. The right open period shown in The Section (d) of FIG. 6 is largely deviated from the viewable period.

The Section (f) of FIG. 6 shows the opening/closing operation of the right shutter 151 under control with the process to shorten the increase period by the convertor 130 (c.f., FIG. 5).

As described with reference to FIG. 4, the data memory 120 stores the right open period data determined by the reception times of the right open and close signals. If the non-reception period exceeds the threshold period, the generator 132 changes the end time of the right open period defined by the right open data to shorten the right open period in step S140 of FIG. 5. Consequently, the length of the right open period is shortened from “880T” to “770T”. The start time of the right open period of the Section (f) in FIG. 6 becomes coincident with the start time of the right open period of the Section (d) of FIG. 6. The end time of the right open period of the Section (f) in FIG. 6 becomes coincident with the end time of the right open period of the Section (c) in FIG. 6. Therefore, the right open period is set in the viewable period even if there is a long non-reception period. Accordingly, the viewer may view a stereoscopic video with little crosstalk.

The process to shorten the right open period shown in FIG. 6 is particularly effective if it is known that the right open period delays from the actual display period of the right frame image in the non-reception period.

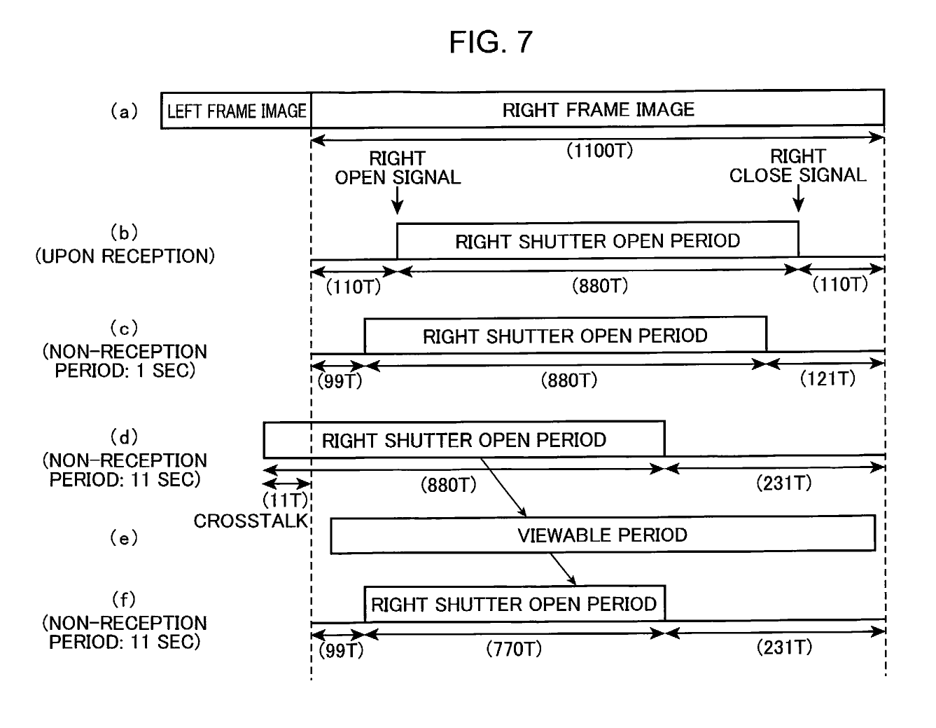

FIG. 7 is a schematic timing chart, which compares the opening/closing operation of the liquid crystal shutter under conventional drive control with an opening/closing operation of the shutter 153 which operates under control of this implementation. Effects of the conversion process described with reference to FIG. 5 are described with reference to FIGS. 1, 2, 4 to 7. The numeric values in the parentheses shown in FIG. 6 indicate time.

The Section (a) of FIG. 7 shows display periods of the right and left frame images on the display device 300. The display device 300 alternately switches and displays the right and left frame images. In the following description, the opening/closing control of the shutter while the right frame image is displayed is mainly described. In the Section (a) of FIG. 7, the period “1100T” is indicated as the display period of the right frame image.

The Section (b) of FIG. 7 shows timing signals transmitted from the display device 300 to the eyewear device 100, and the opening/closing operation of the right shutter 151 in response to the timing signals.

During the display period of the right frame image, the display device 300 transmits a right open signal to open the right shutter 151 (i.e., to notify the start timing at which the increase period starts and the transmitted light amount to the right shutter 151 increases), and a right close signal to close the right shutter 151 (i.e., to notify the end timing at which the increase period ends). The right open signal shown in the Section (b) of FIG. 7 is transmitted at the time “110T” after the display start time of the right frame image. The right close signal is transmitted at the time “110T” before the display end time of the right frame image.

If the receiver 111 of the eyewear device 100 appropriately receives the right open and close signals, the eyewear device 100 controls the opening/closing operation of the right shutter 151, in response to the right open and close signals. For example, if the right open and close signals are appropriately received, the right shutter 151 opens substantially in synchronization with the reception time of the right open signal, and closes substantially in synchronization with the reception time of the right close signal.

The Sections (c) and (d) of FIG. 7 show operation of the right shutter under the conventional control which does not adjust the right open period.

The Section (c) of FIG. 7 shows the opening/closing operation of the right shutter when the non-reception period is 1 second. According to the conventional control, the opening/closing operation of the right shutter in the non-reception period is controlled on the basis of the timing signals acquired before the non-reception period. If the timing signals of the Section (b) in FIG. 7 are used as control references, the open period of the right shutter (right open period) defined by the right open and close signals acquired before the non-reception period is “880T”.

In the Section (c) of FIG. 7, the timing of the right open period advances “11T” during 1 second of the non-reception period. This means that the right open period starts at “99T” after the display start time of the right frame image if there is 1 second of the non-reception period.

In the case of the conventional control, the opening/closing operation of the right shutter is controlled while maintaining the length of the right open period, unlike the principle of this implementation. Therefore, the shift of the end time of the right open period also advances time “11T”. Consequently, if there is 1 second of the non-reception period, the right open time ends at time “121T” before the display end time of the right frame image.

The Section (d) of FIG. 7 shows the opening/closing operation of the right shutter when the non-reception period is 11 seconds. The Section (d) of FIG. 7 shows an advance of the right open period, which increases in proportion to a length of the non-reception period, in order to make description clear. If the non-reception period becomes 11 seconds, the start time of the right open period further advances from the start time of the actually displayed right frame image. Therefore, the right open period starts at “11T” before the display end time of the left frame image. Accordingly, if there are 11 seconds of the non-reception period, the right shutter opens at the time “11T” before the display end time of the left frame image. This means that the viewer views not only the right frame image but also the left frame image with the right eye (i.e., crosstalk). The period “11T”, which shifts into the display period of the left frame image is called “crosstalk period”. As the crosstalk period becomes longer, more light of the left frame image enters the left eye of the viewer, which results in worse qualities of the image perceived by the viewer.

The Section (e) of FIG. 7 shows a period during which the right frame image may be appropriately viewed (viewable period). If the right open period is set in the viewable period, the viewer may appropriately view the right frame image only with the right eye. The right open period shown in the Section (d) in FIG. 7 is largely deviated from the viewable period.

The Section (f) of FIG. 7 shows the opening/closing operation of the right shutter 151 under control with the process to shorten the increase period by the convertor 130 (c.f., FIG. 5).

As described with reference to FIG. 4, the data memory 120 stores the right open period data determined by the reception times of the right open and close signals. If the non-reception period exceeds the threshold period, the generator 132 changes the start time of the right open period defined by the right open period data, so as to shorten the right open period in step S140 in FIG. 5. Consequently, the length of the right open period is shortened from “880T” to “770T”. The start time of the right open period of the Section (f) of FIG. 7 becomes coincident with the start time of the right open period of the Section (c) of FIG. 7. The end time of the right open period of the Section (f) in FIG. 7 becomes coincident with the end time of the right open period of the Section (d) in FIG. 7. Therefore, the right open period is set in the viewable period even if there is a long non-reception period. Therefore, the viewer may view a stereoscopic video with little crosstalk.

The process to shorten the right open period shown in FIG. 7 is particularly effective when it is known that the right open period advances from the actual display period of the right frame image.

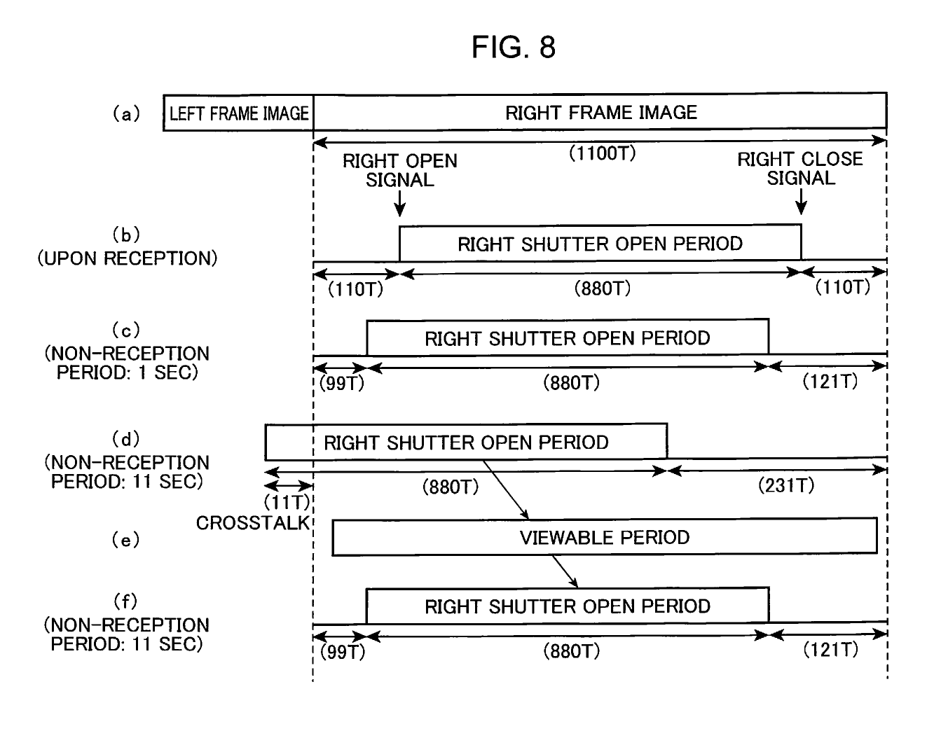

FIG. 8 is a schematic timing chart, which compares an opening/closing operation of the liquid crystal shutter under conventional drive control with an opening/closing operation of the shutter 153 which operates under control of this implementation. Another adjustment method to the right open period when the right open period advances from the period of the actually displayed frame image in the non-reception period is described with reference to FIGS. 1, 2, 4 to 8.

The Sections (a) to (e) of FIG. 8 are the same as the Sections (a) to (e) of FIG. 7. Therefore, the description about the Sections (a) to (e) of FIG. 7 may be applied to the Sections (a) to (e) of FIG. 8.

The Section (f) of FIG. 8 shows the opening/closing operation of the right shutter 151 under control with other adjustment processes to the increase period by the convertor 130.

If the right open period keeps advancing from the actual display period of the right frame, the generator 132 may delay both the start and end times of the right open period defined by the right open period data. The right open period may be then confined to the viewable period while maintaining the length of the right open period. Consequently, the viewer may view a stereoscopic video with little crosstalk.

The shift direction (advance or delay) of the right open period from the actual display period of the right frame image may not be consistent. For example, the shift direction of the right open period may depend on a video displayed by the display device 300. Otherwise, the shift direction of the right open period from the actual display period of the right frame image may be unknown. In such cases, the start time of the right open period may be delayed while the end time of the right open period may be advanced. If the right open period is shortened by changing both the start and end times of the right open period, the right open period is appropriately confined to the viewable period independently from the shift direction of the right open period. Consequently, the viewer may view a stereoscopic video with little crosstalk.

The timing adjustment to the right open period is described with reference to FIGS. 6 to 8. The timing adjustment method to the right open period described with reference to FIGS. 6 to 8 may be similarly applied to timing adjustment to the left open period.

According to the control method described with reference to FIGS. 6 and 7, the increase period, in which an image light amount passing through the shutter 153 increases, is shortened once the non-reception period exceeds the threshold period, so as to decrease the crosstalk. Sudden shortening of the increase period, however, may drop brightness of the image light perceived by the viewer. If the increase period is gradually shortened, the viewer may not perceive a drop in brightness of the image light so much.

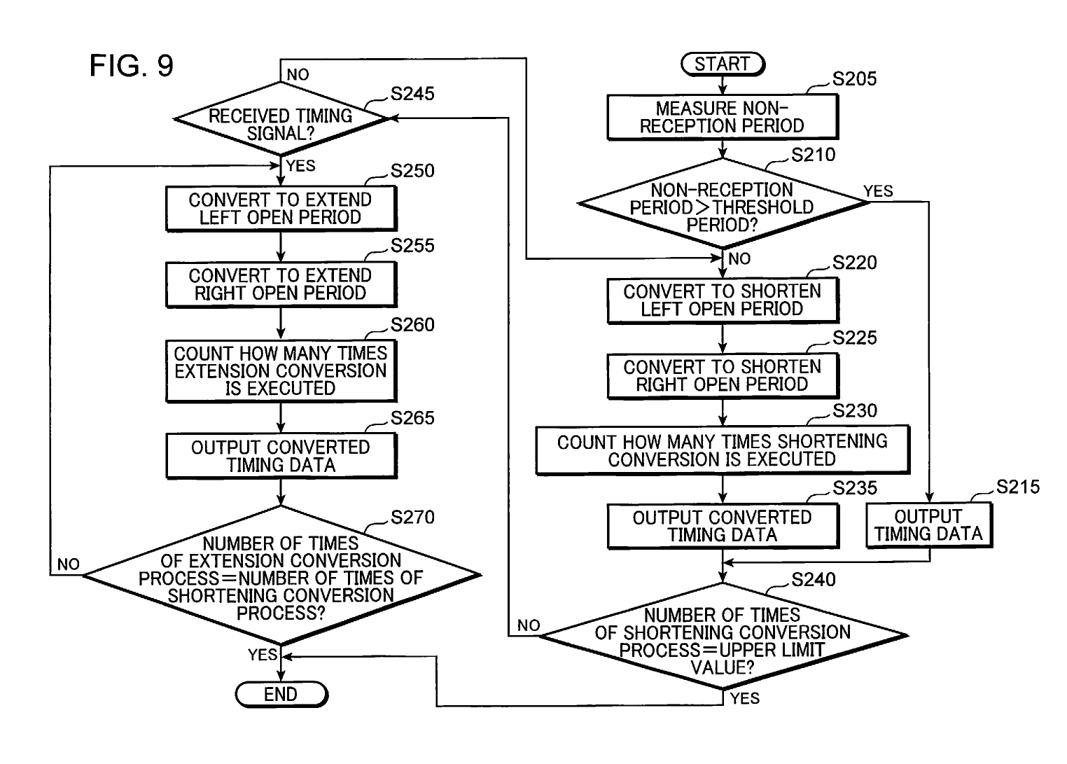

FIG. 9 is a flow chart schematically showing an operation of the eyewear device 100 to gradually adjust the increase period. The operation of the eyewear device 100 to gradually adjust the increase period is described with reference to FIGS. 1, 2 and 9.

### (Step S205)

Unless the reception verifier 110 confirms appropriate reception of the timing signals, step S205 is executed. In step S205, the reception verifier 110 outputs an activation command to the timekeeping portion 131. The timekeeping portion 131 receiving the activation command starts measuring a period without appropriate reception of the timing signals (i.e., non-reception period). Then step S210 is executed.

### (Step S210)

In step S210, the timekeeping portion 131 compares the non-reception period with the threshold period. Unless the non-reception period exceeds the threshold period, step S215 is executed. If the non-reception period exceeds the threshold period, step S220 is then executed.

### (Step S215)

In step S215, the data memory 120 outputs the timing data to the generator 132. The generator 132 outputs the timing data to the flywheel portion 140 without the conversion process on the timing data. The flywheel portion 140 generates and outputs control signals to control the shutter portion 150 in response to the timing data. Then step S240 is executed.

### (Step S220)

In step S220, the generator 132 converts the timing data into converted timing data so as to shorten the increase period indicated by the left open period data of the timing data stored in the data memory 120 (a period in which a light amount entering the left eye increases). The shortened amount of the increase period is preferably set to a value with which the viewer is less likely to perceive a drop in brightness. The left open period data to indicate the increase period shortened by the conversion process in step S220 is exemplified as the converted period data. Then step S225 is executed.

### (Step S225)

In step S225, the generator 132 converts the timing data into converted timing data so as to shorten the increase period indicated by the right open period data of the timing data stored in the data memory 120 (a period in which a light amount entering the right eye increases). The shortened amount of the increase period is preferably set to a value with which the viewer is less likely to perceive a drop in brightness. The right open period data to indicate the increase period shortened by the conversion processing in step S225 is exemplified as the converted period data. Then step S230 is executed.

### (Step S230)

In step S230, it is counted how many times the data conversion process is executed in steps S220, S225 to shorten the increase period. Then step S235 is executed.

### (Step S235)

In step S235, the converted timing data, which are acquired by the data conversion process executed in steps S220, S225, are output to the flywheel portion 140. The flywheel portion 140 generates and outputs control signals for controlling the shutter portion 150 in response to the converted timing data. Consequently, the shutter 153 opens during the increase period, which is slightly shortened. Therefore, the viewer is less likely to perceive a drop in brightness of the image light due to shortening the increase period. Then step S240 is executed.

### (Step S240)

An upper limit value is preset for how many times steps S220 and S225 are processed. The upper limit value is set so that the brightness of the image light does not excessively drop. In step S240, the convertor 130 compares the upper limit value with how many times steps S220 and S225 are processed. Once the processed number of times of steps S220 and S225 reaches the upper limit value, the process of the increase period ends. At this moment, the eyewear device 100 may transmit error messages to the viewer. For example, the eyewear device 100 may flash a light emitter (not shown) included in the eyewear device 100, so as to notify the viewer that communication problems occur between the display device 300 and the eyewear device 100. Alternatively, the viewer may be notified of the communication problems between the display device 300 and the eyewear device 100 by means of a different method such as voice or vibration. Unless the processed number of times of steps S220 and S225 reaches the upper limit value, step S245 is executed.

### (Step S245)

In step S245, the reception verifier 110 confirms reception of the timing signals. Unless appropriate reception of the timing signal is confirmed, step S220 is executed. Therefore, the processing loop including steps S220, S225, S230, S235, S240 and S245 is established. By repeating this processing loop, the increase period, in which an image light amount passing through the shutter 153 increases, is gradually shortened. The increase period defined by the converted timing data, which are sequentially output from the generator 132 to the flywheel portion 140, is gradually shortened. Therefore, the viewer is less likely to perceive a drop in brightness of the image light. If appropriate reception of the timing signal is confirmed, step S250 is executed.

### (Step S250)

In step S250, the generator 132 converts the timing data into converted timing data so as to extend the increase period indicated by the left open period data of the timing data stored in the data memory 120 (a period in which a light amount entering the left eye increases). The amount of extending the increase period is set to be the same as the amount of shortening the increase period set in step S220. The left open period data to indicate the increase period extended by the conversion process in step S250 is exemplified as the converted period data. Then step S255 is executed.

### (Step S255)

In step S225, the generator 132 converts the timing data into converted timing data so as to extend the increase period indicated by the right open period data of the timing data stored in the data memory 120 (a period in which a light amount entering the right eye increases). The amount of extending the increase period is set to be the same as the amount of shortening the increase period set in step S225. The right open period data to indicate the increase period extended by the conversion process in step S255 is exemplified as the converted period data. Then step S260 is executed.

### (Step S260)

In step S260, it is counted how many times the data conversion process is executed in steps S250, S255 to extend the increase period. Then step S265 is executed.

### (Step S265)

In step S265, the converted timing data, which are acquired by the data conversion process executed in steps S250, S255, are output to the flywheel portion 140. The flywheel portion 140 generates and outputs control signals to control the shutter portion 150 in response to the converted timing data. Consequently, the shutter 153 opens during the increase period which is slightly extended. Therefore, the viewer is less likely to perceive an increase in brightness of the image light due to extending the increase period. Then step S270 is executed.

### (Step S270)

In step S270, the convertor 130 compares the processed number of times of steps S250, S255 with the processed number of times of steps S220, S225. If the processed number of times of the extension process executed in steps S250, S255 is the same as the processed number of times of the shortening process executed in steps S220, S225, the selector 154 selects a control signal, which is output from the reception verifier 110. Consequently, the shutter 153 is controlled in response to the control signals output from the reception verifier 110. When step S270 is executed, the increase period is substantially the same as the increase period defined by the timing signal before the non-reception period. Therefore, even if the selector 154 switches the selection of the control signal from the control signal, which is output from the flywheel portion 140, to the control signal, which is output from the reception verifier 110, the viewer is less likely to perceive a change in brightness.

Unless the number of times of the extension process executed in steps S250, S255 reaches the number of times of the shortening process executed in steps S220, S225, the process of step S250 is executed. Therefore, the processing loop including steps S250, S255, S260, S265 and S270 is established. By repeating this processing loop, the increase period, in which an image light amount passing through the shutter 153 increases, is gradually extended. The increase period defined by the converted timing data, which are sequentially output from the generator 132 to the flywheel portion 140, is gradually extended. Therefore, the viewer is less likely to perceive an increase in brightness of the image light.

According to the aforementioned implementations, the increase period, in which an image light amount passing through the shutter 153 increases, is shortened so as to decrease crosstalk once the non-reception period exceeds the threshold period. An appropriate method, which is used to determine whether crosstalk is generated or not, may be additionally incorporated to the adjustment method to a length of the increase period according to this implementation. If it is determined whether crosstalk occurs or not before the adjustment to a length of the increase period of this implementation, the length of the increase period may be adjusted only if the crosstalk occurs. Unless crosstalk occurs, the increase period is maintained. Therefore, brightness of a video perceived by the viewer does not drop much. If it is determined that crosstalk occurs, the crosstalk is reduced by shortening the increase period, as described above. Consequently, a brightness level of the image perceived by the viewer is kept while crosstalk is decreased.

The aforementioned convertor 130 of the eyewear device 100 may shorten a length of the increase period, in which an image light amount passing through the shutter 153 increases, in response to a period length without reception of the timing signals. Accordingly, crosstalk may be appropriately reduced. The configuration to shorten a length of the increase period is not limited to the illustrated elements. The principles of this implementation may be realized by various changes, omissions and additions of the disclosed elements, and should not be limited in any way by the detailed disclosure of the aforementioned implementations.

The aforementioned implementations mainly include the following features. The eyewear device with the following features may preferably prevent crosstalk even if a period without reception of signals, which notify the timing to adjust a light amount entering the left or right eye, continues for a predetermined period or longer. Therefore, a viewer wearing the eyewear device may view a high quality stereoscopic video.

An eyewear device according to one aspect of the aforementioned implementation assists in viewing a video so that the video is stereoscopically perceived. The eyewear device includes a light amount adjuster which increases and decreases a transmission amount of image light so as to adjust a light amount that enters each of left and right eyes; and a controller configured to control the light amount adjuster in response to a timing signal for notifying a timing of an increase period during which the transmission amount is increased. The controller includes a detector configured to detect a non-reception period in which the timing signal is not received; a storage portion configured to store period data which define a length of the increase period in the non-reception period; and a flywheel controller configured to control the light amount adjuster in the non-reception period in response to the period data. If the non-reception period exceeds a threshold period which is defined for the non-reception period, the flywheel controller controls the light amount adjuster so that the increase period is shortened.

According to the aforementioned configuration, the eyewear device assists in viewing a video so that the video is stereoscopically perceived. The light amount adjuster of the eyewear device increases and decreases a transmission amount of image light so as to adjust a light amount which enters each of the left and right eyes. The controller controls the light amount adjuster in response to the timing signal for notifying the timing of the increase period in which the transmission amount is increased. Since the eyewear device adjusts the light amount which enters each of the left and right eyes in response to the timing signal, the viewer viewing a video by means of the eyewear device may stereoscopically perceive the video.

The detector of the controller detects the non-reception period during which the timing signal is not received. The storage portion of the controller stores period data which define a length of the increase period in the non-reception period. The flywheel controller of the controller controls the light amount adjuster in the non-reception period in response to the period data. Therefore, the light amount adjuster may appropriately adjust a light amount which enters the left and right eyes even during the non-reception period.

If the non-reception period exceeds the predetermined threshold period, the flywheel controller controls the light amount adjuster so that the increase period is shortened. Therefore, even if the timing is shifted between a video and the increase period during the non-reception period, there may be little crosstalk. Consequently, the viewer wearing the eyewear device may view a high quality stereoscopic video.

In the aforementioned configuration, the detector may include a determination portion configured to determine whether the timing signal is received. The determination portion, which determines that the timing signal is not received even after the threshold period passes, may convert the period data into converted period data so that the increase period is shortened. The flywheel controller may control the light amount adjuster in response to the converted period data.

According to the aforementioned configuration, the determination portion may determine whether the timing signal is received. The determination portion, which determines that the timing signal is not received even after the threshold period passes, may convert the period data into the converted period data so that the increase period is shortened. The flywheel controller may control the light amount adjuster in response to the converted period data. Therefore, even if the timing is shifted between the video and the increase period during the non-reception period, there may be little crosstalk. Consequently, the viewer wearing the eyewear device may view a high quality stereoscopic video.

In the aforementioned configuration, the timing signal may notify a start timing, at which the increase period starts, and an end timing, at which the increase period ends. The determination portion determining that the timing signal is not received even after the threshold period passes may change at least one of the start and end timings to generate the converted period data.

According to the aforementioned configuration, the timing signal may notify the start timing, at which the increase period starts, and the end timing, at which the increase period ends. The determination portion determining that the timing signal is not received even after the threshold period passes may change at least one of the start and end timings to generate the converted period data. Therefore, the increase period is appropriately shortened. Accordingly, even if the timing is shifted between the video and the increase period during the non-reception period, there may be little crosstalk. Consequently, the viewer wearing the eyewear device may view a high quality stereoscopic video.

In the aforementioned configuration, the determination portion, which determines that the timing signal is not received even after the threshold period passes, may convert the period data into the converted period data so that the increased period is gradually shortened.

According to the aforementioned configuration, the determination portion determining that the timing signal is not received even after the threshold period passes may convert the period data into the converted period data so that the increase period is gradually shortened. Therefore, the viewer is less likely to perceive a drop in brightness of the video due to the shortening of the increase period.

In the aforementioned configuration, the determination portion determining that the timing signal is received after the non-reception period may convert the period data into the converted period data so that the increase period is gradually extended.

According to the aforementioned configuration, the determination portion, which determines that the time signal is received after the non-reception period, may convert the period data into the converted period data so that the increase period is gradually extended. Therefore, the viewer is less likely to perceive an increase in brightness of the video due to the extension of the increase period.

In the aforementioned configuration, the storage portion may store the start and end timings. The flywheel controller may control the light amount adjuster in response to the period data which are defined by the start and end timings while the non-reception period does not exceed the threshold period.

According to the aforementioned configuration, the storage portion stores the start and end timings. While the non-reception period does not exceed the threshold period, the flywheel controller controls the light amount adjuster in response to the period data which is defined by the start and end timings. Therefore, the light amount adjuster may appropriately adjust a light amount which enters each of the left and right eyes.

In the aforementioned configuration, the video may include a left eye frame image, which is viewed with the left eye, and a right eye frame image, which is viewed with the right eye. The timing signal may include a left timing signal for notifying a period, in which the light amount entering the left eye increases, and a right timing signal for notifying a period, in which the light amount entering the right eye increases. The light amount adjuster may increase the light amount entering the left eye in response to the left timing signal while the left frame image is displayed, and increase the light amount entering the right eye in response to the right timing signal while the right frame image is displayed.

In the aforementioned configuration, the video may include a left eye frame image, which is viewed with the left eye, and a right eye frame image, which is viewed with the right eye. The timing signal may include a left timing signal for notifying a period, in which a light amount entering the left eye increases, and a right timing signal for notifying a period, in which a light amount entering the right eye increases. The light amount adjuster may increase the light amount entering the left eye in response to the left timing signal while the left frame image is displayed. The light amount adjuster may increase the light amount entering the right eye in response to the right timing signal while the right frame image is displayed. Therefore, the light amount adjuster may appropriately adjust the light amount entering each of the left and right eyes, so that the viewer may stereoscopically perceive the video.

### INDUSTRIAL APPLICABILITY

The principles of the aforementioned implementations may preferably prevent crosstalk even if a period without signal reception, which notifies the timing to adjust a light amount entering the left and right eyes, continues for a predetermined period or more. Therefore, the aforementioned principles may be suitably applied to the eyewear device for assisting in viewing a stereoscopic video. The eyewear device according to the principles of the aforementioned implementations may provide a viewer with a stereoscopic video at a high quality level.

1. An eyewear device for assisting in viewing a video so that the video is stereoscopically perceived, comprising:
a light amount adjuster which increases and decreases a transmission amount of image light so as to adjust a light amount that enters each of left and right eyes; and
a controller configured to control the light amount adjuster in response to a timing signal for notifying a timing of an increase period during which the transmission amount is increased, wherein
the controller includes:
a detector configured to detect a non-reception period in which the timing signal is not received;
a storage portion configured to store period data which define a length of the increase period in the non-reception period; and
a flywheel controller configured to control the light amount adjuster in the non-reception period in response to the period data, and
if the non-reception period exceeds a threshold period which is defined for the non-reception period, the flywheel controller controls the light amount adjuster so that the increase period is shortened.

2. The eyewear device according to claim 1, wherein
the detector includes a determination portion configured to determine whether the timing signal is received, and
the determination portion, which determines that the timing signal is not received even after the threshold period passes, converts the period data into converted period data so that the increase period is shortened, and
the flywheel controller controls the light amount adjuster in response to the converted period data.

3. The eyewear device according to claim 2, wherein
the timing signal notifies a start timing, at which the increase period starts, and an end timing, at which the increase period ends, and
the determination portion, which determines that the timing signal is not received even after the threshold period passes, changes at least one of the start and end timings to generate the converted period data.

4. The eyewear device according to claim 2, wherein
the determination portion, which determines that the timing signal is not received even after the threshold period passes, converts the period data into the converted period data so that the increased period is gradually shortened.

5. The eyewear device according to claim 2, wherein
the determination portion, which determines that the timing signal is received after the non-reception period, converts the period data into the converted period data so that the increase period is gradually extended.

6. The eyewear device according to claim 3, wherein
the storage portion stores the start and end timings, and
the flywheel controller controls the light amount adjuster in response to the period data which are defined by the start and end timings while the non-reception period does not exceed the threshold period.

7. The eyewear device according to claim 1, wherein
the video includes a left eye frame image, which is viewed with the left eye, and a right eye frame image, which is viewed with the right eye,
the timing signal includes a left timing signal for notifying a period, in which the light amount entering the left eye increases, and a right timing signal for notifying a period, in which the light amount entering the right eye increases, and
the light amount adjuster increases the light amount entering the left eye in response to the left timing signal while the left frame image is displayed, and increases the light amount entering the right eye in response to the right timing signal while the right frame image is displayed.
